(19) United States
(12) Patent Application Publication
(10) Pub. No.: US 2006/0251196 A1
(43) Pub. Date: Nov. 9, 2006

(54) Recovering a signal without a phase locked loop

(75) Inventors: Hendrik Ten Pierick, Eindhoven (NL); Christinus Johannes Van Valburg, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/564,922

(22) PCT Filed: Jul. 16, 2004
(86) PCT No.: PCT/IB04/51240

§ 371 Date: Jan. 17, 2006

(30) Foreign Application Priority Data
Jul. 21, 2003 (EP) 03102241.1

(51) Int. Cl. H04B 1/10

(52) U.S. Cl. 375/350

(57) ABSTRACT

An arrangement for recovering a first digital signal (7,31) from a digital input signal (20) comprises a digital filter (29) for filtering the digital input signal (20), a digitally controlled oscillator 28 for generating a digital reference signal (21) and a digital phase detector (22) for determining a phase difference (25) between the filtered digital input signal (27) and the digital reference signal (21). The first digital signal (7, 31) can be recovered by adding the determined phase difference (25) to the phase of the digital reference signal (21).

The present invention relates to an arrangement for recovering a digital signal from a digital input signal, a receiver and a radio comprising such an arrangement. The invention further relates to a computer-programming product for recovering a digital signal from a digital input signal.

The present invention can be used in receivers, such as a radio receiver or a video/TV receiver for recovering e.g. a pilot signal, a center frequency signal or a color burst signal. These kinds of receivers are generally known in the art and typically make use of a phase locked loop to lock onto the frequency of the recoverable signal. In general, however, phase locked loops are difficult to design and are sometimes even impractical. For example, when the phase of the recoverable signal is not a constant value but changes due to poor receiving conditions or when the recoverable signal is severely degraded by the presence of noise. In these cases, the phase locked loop might not be able to track the phase of the signal, which causes an erroneous frequency lock.

It is an object according to the present invention to provide an arrangement for recovering a signal without using a phase locked loop. To this end the arrangement for recovering a first digital signal from a digital input signal, comprises:
a digital filter for filtering the digital input signal;
a digitally controlled oscillator for generating a digital reference signal; and
a digital phase detector for determining a phase difference between the filtered digital input signal and the digital reference signal; in which the first digital signal is recovered by adding the determined phase difference to the phase of the digital reference signal.

The invention is based upon the insight that the first digital signal can be recovered by determining the phase difference between an arbitrary but well-defined reference signal and the recoverable signal, followed by an addition of the phase difference to the phase of the reference signal.

An arrangement for recovering a signal without a phase locked loop is known from U.S. Pat. No. 5,404,405 but an alternative solution is provided there in which the signal is recovered by means a FIR (Finite Impulse Response) filter which has a complex implementation particularly with a narrow passband.

In an embodiment of the arrangement according to the present invention an offset value is added to the phase of the recovered first digital signal for compensating a filter delay of the digital filter. Herewith, the distortive effect of filter delay that may cause a phase error in the recovered signal can be corrected.

In another embodiment of the arrangement according to the present invention the arrangement comprises a first digital mixer for frequency down-converting the digital input signal before filtering. This embodiment has the advantage of a less complex implementation of the digital filter.

In an embodiment of the arrangement according to the present invention the digital input signal is a stereo multiplex signal and the recovered first digital signal is a pilot signal. Herewith, the arrangement can be used to recover a pilot signal in a convenient way.

In an embodiment of the arrangement according to the present invention a phase of a pilot signal is multiplied by a multiplier for recovering a second digital signal. By multiplying the phase of the (19 kHz) pilot by a multiplier, other (sub)carriers such as, the 38 kHz suppressed carrier signal, the 57 kHz RDS sub carrier or the 76 kHz DARC sub carrier can easily be recovered.

In another embodiment of the arrangement according to the present invention the arrangement further comprises a stereo decoder for decoding the stereo multiplex signal into at least a first and a second signal. Herewith, the left and right stereo channels, which are coded in received stereo multiplex signal, can conveniently be decoded.

In an embodiment of the arrangement according to the present invention, the stereo multiplex signal comprises a sum signal and a difference signal, the former signal being decoded by adding the sum signal to a frequency down-converted difference signal, the latter signal being decoded by subtracting the frequency down-converted difference signal from the sum signal.

In an embodiment of an arrangement according to the present invention the difference signal is frequency down-converted by means of the recovered suppressed carrier signal. Since the suppressed carrier signal is directly derived from the recovered pilot signal it has the correct frequency and phase to shift the difference signal of the stereo multiplex signal to baseband.

In another embodiment of the arrangement according to the present invention the phase offset value is further arranged to control the amplitude of the difference signal. Herewith, it is possible to manipulate the decoded first and second signals for example, from mono to stereo signals.

Embodiments of a receiver, a radio and a computer programming product according to the present invention, correspond with the embodiments of the arrangement according to the present invention.

These and other aspect of the present invention will be elucidated further by means of the following drawings.

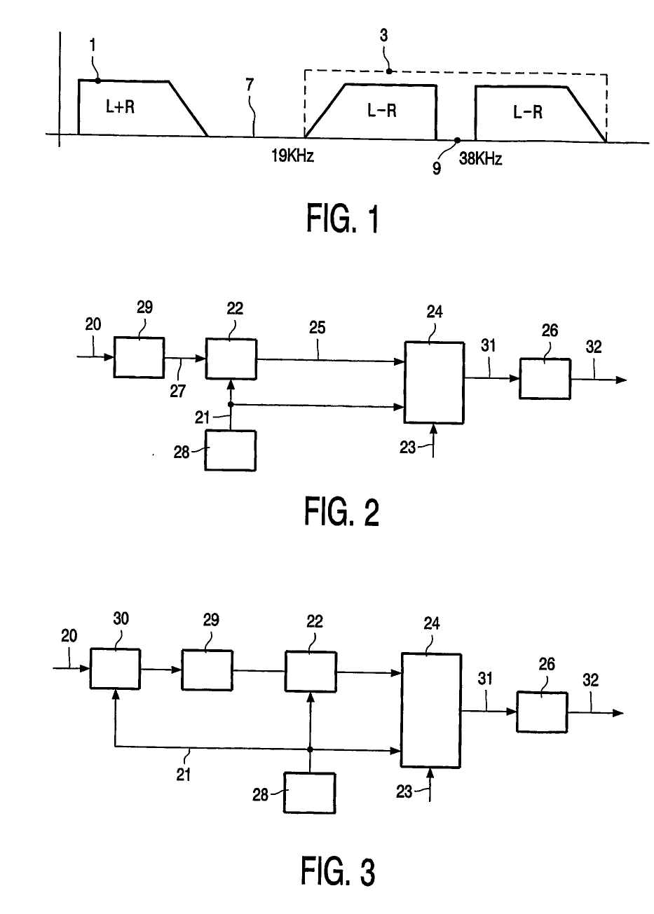

FIG. 1 shows a stereo multiplex signal

FIG. 2 shows an embodiment of the arrangement according to the present invention

FIG. 3 shows a further embodiment of the arrangement according to the present invention

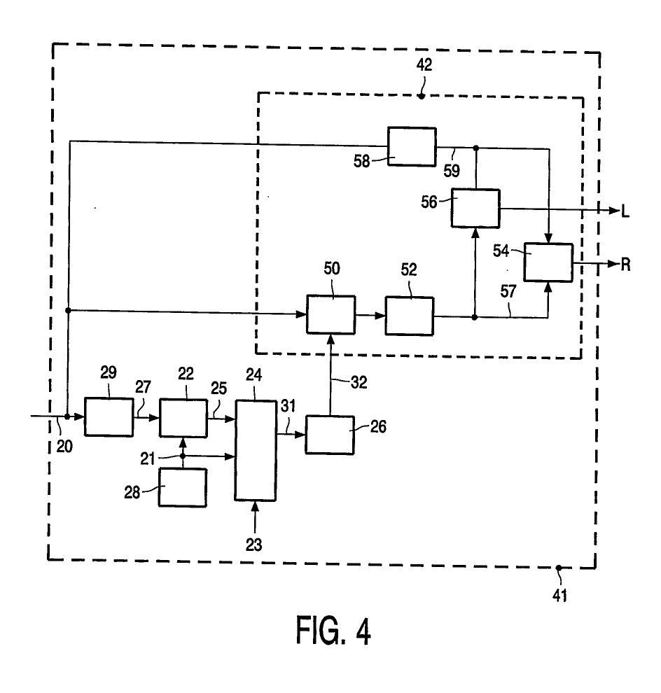

FIG. 4 shows an embodiment of the arrangement according to the present invention that is used as a stereo decoder.

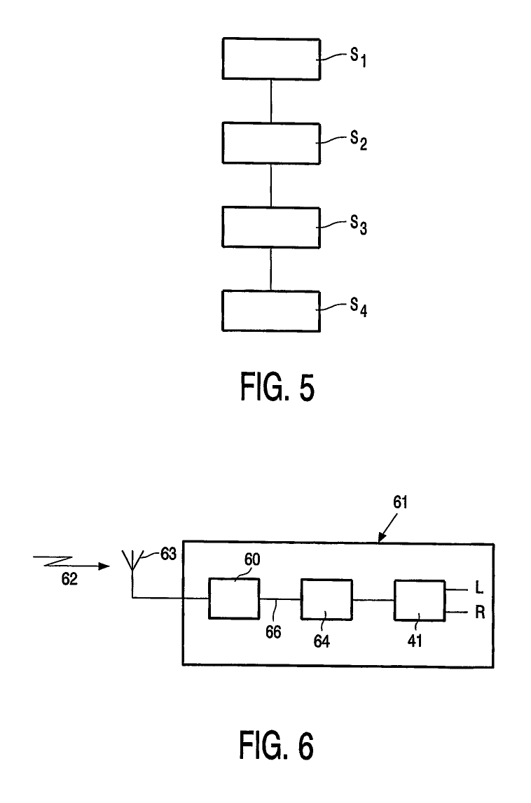

FIG. 5 shows a flow chart showing the essential steps to be carried out by a computer programming product in order to recover a digital signal from a digital input signal.

FIG. 6 shows a radio device comprising an arrangement according to the present invention.

FIG. 1 shows a stereo multiplex (MPX) signal in which the left and right stereo channels are encoded. The stereo multiplex signal comprises a sum signal 1 and difference signal 3 The sum signal 1 is the summation of the left and right stereo channels, the difference signal 3 is the subtraction of the left and right stereo channels. The left stereo channel is obtainable by adding together the sum 1 and the difference signal 3. The right stereo channel is obtainable by subtracting the difference signal 3 from the sum signal 1. The stereo multiplex signal further comprises a 19 kHz pilot signal 7 which is used for the regeneration of the 38 kHz suppressed carrier signal 9 which is required for the demodulation of the difference signal 3.

FIG. 2 shows an embodiment according to the present invention. Digital input signal 20 comprises a recoverable digital signal such as a center frequency signal or a pilot signal. The recoverable digital signal is filtered from the digital input signal by means of digital baseband filter 29. Typically, the recoverable signal is surrounded by noise which in conventional PLL based receivers may cause a phase inversion of the recovered signal or may cause the PLL to lock onto the wrong frequency. These problems become particularly apparent during poor receiving conditions. This may lead to a considerable and unacceptable degradation of the received signals. According to the present invention, these problems can be resolved by first determining a phase difference between the filtered signal 27 and the phase of an arbitrary but well-defined reference signal 21 followed by an addition of the phase difference to the phase of the reference signal 21. The phase detector can be based on a hardware or a software implementation of the Cordic algorithm by Jack E. Volder which is well known to the man skilled in the art. However, filter 22 may introduce a phase error due to the presence of filter delay. According to the present invention, this phase error, however, can be easily corrected by adding a constant correction factor 23 to the phase of the recovered signal. FIG. 2 further comprises multiplier 26 for multiplying the phase of the recovered signal 31 by a multiplication factor so as to derive other signals. In case of signal 31 being pilot signal 7 having a frequency of 19 kHz and a corresponding phase of (2*π*19*10³*t) radians, a multiplication factor of 2 yields the corresponding suppressed carrier signal 9 having a frequency of 38 kHz and a phase of (2*π*38*10³*t) radians. Likewise, by means of other multiplication factors, additional signals can be derived from the 19 kHz pilot signal as well, such as the 57 kHz RDS sub carrier (multiplication factor of 3) or the 76 kHz DARC sub carrier (multiplication factor of 4).

FIG. 3, shows another embodiment according to the present invention wherein input signal 20 is first frequency down-converted by means of digital mixer 30 before filtering. In this case, filter 29 is a digital low pass digital filter. Mixer 30 uses reference signal 28 as a mixing signal. This embodiment has the advantage that the implementation of filter 29 is less complex compared to the situation as described in FIG. 1.

FIG. 4 shows an embodiment according to the present invention wherein stereo decoder 42 is used to decode the stereo multiplex signal 20. It is assumed that the stereo multiplex signal 20 is a digital signal which, for example, has been digitized by means of a conventional analog-to-digital converter (not shown here). The stereo multiplex signal 20 comprises the 19 kHz pilot signal 7, the sum signal 1 and the difference signal 3. The difference signal 9 has been modulated around the 38 kHz suppressed carrier signal 9. The 19 KHz pilot signal 7, 31 is recovered from the stereo multiplex signal 20 according to the present invention. The 38 kHz suppressed carrier signal 9,32 is derived from the 19 kHz pilot signal 7,31, by doubling the phase of the recovered pilot signal 7, 31.

The left stereo channel L is obtained by adding together in the adder 56 the sum signal 1, 59 and the difference signal 3, 59. The right stereo channel R is obtained by subtracting in subtracter 54 the difference signal 3, 57 from the sum signal 1,59. The difference signal 3 is obtained from the stereo multiplex signal 20 by frequency down converting 50 and low-pass filtering 52 the stereo multiplex signal 20. The stereo multiplex signal 20 can be frequency down converted by means of a conventional (digital) mixer 50 that uses the recovered suppressed carrier signal 9, 32 as a mixing signal.

Phase offset signal 23 is used to compensate the phase distortion which may be introduced into the recovered pilot signal 31 by the filter delay of filter 29. However, this phase offset signal can also be used to manipulate the phase of suppressed carrier signal 9,32. Herewith the amplitude of difference signal 57 can be influenced which in turn influences the recoverable left (L) and right (R) channels. For example, from stereo channels to mono channels.

FIG. 5 shows a flow chart comprising the steps for recovering a digital signal from a digital input signal. As a first step SI, the digital input signal 20 is digitally filtered to extract the digital signal 27. In the second step a digital reference signal 21 is generated which is used to determine the phase of the extracted digital signal 27. In step S3 the phase difference 25 between the extracted digital signal 27 and the reference signal 21 is determined which in the next phase S4 is added to the phase of the reference signal 21.

FIG. 6 shows a radio device 61 according to the present invention. Radio device 61 receives radio signals 61 through the air by means of antenna 63. Tuner 60 selects one specific radio signal as the preferred radio signal 66 which is a stereo multiplex signal as shown in FIG. 1. Signal 66 is digitized by means of analog-to-digital converter 64. Stereo decoder 42 is used to decode the left L and right R channels of the stereo multiplex signal 66.

It is to be noted that the above-mentioned embodiments illustrate rather than limit the invention, and that those skilled in the art will be able to design many alternative embodiments without departing from the scope of the appended claims. The embodiments can be realized either in hardware or in software. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Arrangement for recovering a first digital signal (7,31) from a digital input signal (20), the arrangement comprising:
a digital filter (29) for filtering the digital input signal (20);
a digitally controlled oscillator 28 for generating a digital reference signal (21); and
a digital phase detector (22) for determining a phase difference (25) between the filtered digital input signal (27) and the digital reference signal (21);
in which the first digital signal (7,31) is recovered by adding the determined phase difference (25) to the phase of the digital reference signal (21).

2. Arrangement according to claim 1, wherein an offset value (23) is added to the phase of the recovered first digital signal (31) to compensate a filter delay of the digital filter (29).

3. Arrangement according to claim 1, wherein the arrangement comprises a first digital mixer (30) for frequency down-conversion of the digital input signal (20) before filtering.

4. Arrangement according to claim 3, wherein the first digital mixer (30) uses the digital reference signal (21) as a mixing signal.

5. Arrangement according to claim 1, wherein the digital input signal (2) is a stereo multiplex signal and the recovered first digital (31) signal is a pilot signal (7).

6. Arrangement according to claim 5, wherein a phase of a pilot signal is multiplied (26) with a multiplication factor to recover a second digital signal (32).

7. Arrangement according to claim 6, wherein the second digital signal (32) is a suppressed carrier signal (9) of the stereo multiplex signal.

8. Arrangement according to claim 5, wherein the arrangement further comprises a stereo decoder (42) for decoding the stereo multiplex signal into at least a first (L) and a second (R) signal.

9. Arrangement according to claim 8, wherein the stereo multiplex signal comprises a sum signal (1) and a difference signal (3), the first signal (L) being decoded by adding (56) the sum signal to a frequency down-converted difference signal, the second signal (R) being decoded by subtracting (54) the frequency down-converted difference signal 10 from the sum signal.

10. Arrangement according to claim 9, wherein the difference signal (3) is frequency down-converted by means of the recovered suppressed carrier signal (9,32).

11. Arrangement according to claim 10, wherein the phase offset value (23) is further arranged to control the amplitude of difference signal (57).

12. Receiver comprising an arrangement for recovering a first digital signal (7,31) from a digital input signal (20), the arrangement comprising:
a digital filter (29) for filtering the digital input signal (20);
a digitally controlled oscillator 28 for generating a digital reference signal (21); and
a digital phase detector (22) for determining a phase difference (25) between the filtered digital input signal (27) and the digital reference signal (21);
in which the first digital signal (7,31) is recovered by adding the determined phase difference (25) to the phase of the digital reference signal (21).

13. Radio (61) comprising an arrangement for recovering a first digital signal (7,31) from a digital input signal (20), the arrangement comprising:
a digital filter (29) for filtering the digital input signal (20);
a digitally controlled oscillator 28 for generating a digital reference signal (21); and
a digital phase detector (22) for determining a phase difference (25) between the filtered digital input signal (27) and the digital reference signal (21); in which the first digital signal (7,31) is recovered by adding the determined phase difference (25) to the phase of the digital reference signal (21).

14. Computer programming product for recovering a first digital signal (7,31) from a digital input signal (20), the arrangement being arranged to perform the steps of:
filtering the digital input signal with a digital filter (29);
generating a digital reference signal;
determining a phase difference (25) between the digital input signal (20) and the digital reference signal (21); and
digitally add (24) the determined phase difference (25) to the phase of the digital reference signal (21) to recover the first signal (7,31).
